(19) United States
(12) Patent Application Publication
(10) Pub. No.: US 2006/0109832 A1
(43) Pub. Date: May 25, 2006

(54) Apparatus and method of aggregation of data packets streams

(76) Inventor: Boris Ginzburg, Haifa (IL)

Correspondence Address: PEARL COHEN ZEDEK LATZER, LLP, 1500 BROADWAY, 12TH FLOOR, NEW YORK, NY, 10036, US

(21) Appl. No.: 10/994,330

(22) Filed: Nov. 23, 2004

(51) Int. Cl. H04L 12/42; H04L 12/403

(52) U.S. Cl. 370/346; 370/449

(57) ABSTRACT

Briefly, a method and apparatus to aggregate at least first polling service of a first data traffic stream with a second polling service of a second data traffic stream into an aggregated service by aggregating service time periods and polling intervals of the at least first and second services.

### BACKGROUND OF THE INVENTION

A wireless local area network (WLAN) may include a basic service set (BSS). The BSS may include an access point (AP) and one or more stations (STA). In order to receive data packets from the one or more stations, the AP may periodically request to receive data packets from the one or more stations. This method of network managing is known in the art of data communication as a polling method. According to one exemplary polling method, the AP may provide aggregated services of polling data from the one or more stations. The AP may include a scheduler that may schedule the aggregated services of polling sequences of data of one or more data streams transmitted from the one or more stations. The scheduler may schedule the aggregated services to occur in predetermined periodic intervals and for predetermined time periods.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a schematic illustration of a wireless communication system according to an exemplary embodiment of the present invention; and

FIG. 2 is an illustration of a timing diagram of an aggregate data polling service according to some exemplary embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, or transmission devices.

It should be understood that the present invention may be used in a variety of applications. Although the present invention is not limited in this respect, the circuits and techniques disclosed herein may be used in many apparatuses such as stations of a radio system. Stations intended to be included within the scope of the present invention include, by way of example only, wireless local area network (WLAN) stations, two-way radio stations, digital system stations, analog system stations, cellular radiotelephone stations, and the like.

Types of WLAN stations intended to be within the scope of the present invention include, although are not limited to, mobile stations, access points, stations for receiving and transmitting spread spectrum signals such as, for example, Frequency Hopping Spread Spectrum (FHSS), Direct Sequence Spread Spectrum (DSSS), Complementary Code Keying (CCK), Orthogonal Frequency-Division Multiplexing (OFDM) and the like.

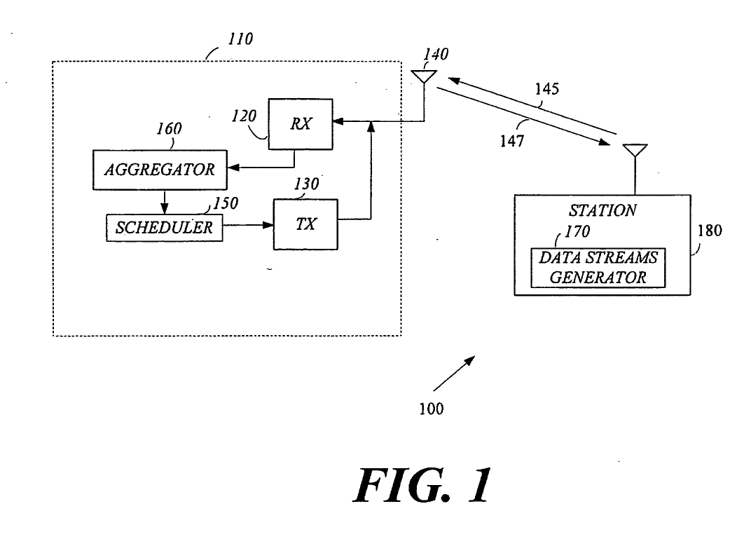

Turning first to FIG. 1, a wireless communication system 100, for example, a WLAN, according to embodiments of the present invention, is shown. Although the scope of the present invention is not limited in this respect, the exemplary WLAN 100 may be defined, by IEEE 802.11-1999 standard, as a BSS. For example, the BSS may include at least one communication station, for example, a station 180 and an access point (AP) 110, if desired. According to this embodiment of the invention station 180 may include a data streams generator 170, and AP 110 may include a receiver (RX) 120, a transmitter (TX) 130, an at least one antenna 140, a scheduler 150 and an aggregator 160.

Although the scope of the present invention is not limited in this respect, antenna 140 may be an omni-directional antenna, a monopole antenna, a dipole antenna, an end fed antenna, a circularly polarized antenna, a micro-strip antenna, a diversity antenna, an antenna array, an internal antenna or the like.

Although the scope of the present invention is not limited in this respect, WLAN 100 may employ quality of service (QoS) mechanisms, schemes, algorithms and/or methods to control data streams transactions across the network. For example, AP 110 may use a QoS mechanism and/or algorithm that may be based on reservation of transmission opportunities (TXOPs) per a transmission of data stream. According to this exemplary embodiment, station 180 may request reservation of TXOPs for its own transmissions and for AP 110 transmissions. AP 110 may accept or reject the request based on an agreed WLAN control policy, for example, admission control policy of IEEE-802.11-1999 standard, if desired.

Although the scope of the present invention is not limited in this respect, AP 110 may accept the request for reservation of TXOPs and scheduler 150 may schedule TXOPs for both AP 110 and station 180. According to some exemplary embodiments of the invention, AP 110 may poll portions of data from the data streams of station 180 and may directly deliver one or more queued data frames to station 180, if desired. In some embodiments of the invention, the above described mechanism and/or algorithm may be used for applications such as, for example, voice and video applications which may need a periodic service from scheduler 150

Although the scope of the present invention is not limited to this respect, data streams generator 170 of station 180 may generate two or more data streams based on an application that operates on station 180 For example, the data streams may include audio, video, text, data and the like. According to an exemplary embodiment of the invention, station 180 may request an aggregated service from AP 110 to transmit two or more data streams to AP 110. According to this embodiment, station 180 may send an aggregation service request via an upstream link 145. For example, the aggregation service request may include information about transmission parameters of new stream (e.g. data rate, packet length, service interval or the like) and an identification (ID) of an existing stream to which the new stream may be aggregated.

Although the scope of the present invention is not limited in this respect, the aggregation request may be received at AP 110 via antenna 140, receiver 120 and aggregator 160. Scheduler 150 may schedule intervals of service time to serve station 180. For example, scheduler 150 may schedule a first service interval of service time to poll a data frame from a first data stream and may schedule a second service interval of service time to poll a data frame of a second data stream, if desired In some embodiments of the present invention, aggregator 160 may aggregate into a single aggregated service both durations of service intervals and a number of polling intervals, if desired. For example, the durations may be durations of at least the first and second service intervals of polling the at least first and second data streams and the number of polling intervals may include the number of polling intervals of the first and second services, if desired. For example, the number of polling intervals may be the number of polling data frames of the first and/or second data stream from the time of transmitting a first beacon by AP 110 to the time of transmitting a second beacon from AP 110 to station 180.

Although the scope of the present invention is not limited in this respect, in one embodiments of the present invention, the number of polling intervals of the first and second services may be set according to a desired polling interval, for example, the shorter of the polling intervals of at least the first and second services. Furthermore, the duration of an aggregated service poll may be a combination (e.g. sum) of a duration of a poll of the first service and a duration of a poll of the second service, if desired.

According to another embodiment of the invention, the number of polling intervals of the first and second data streams may be selected according to a length of the first service duration and the length of the second service duration, if desired.

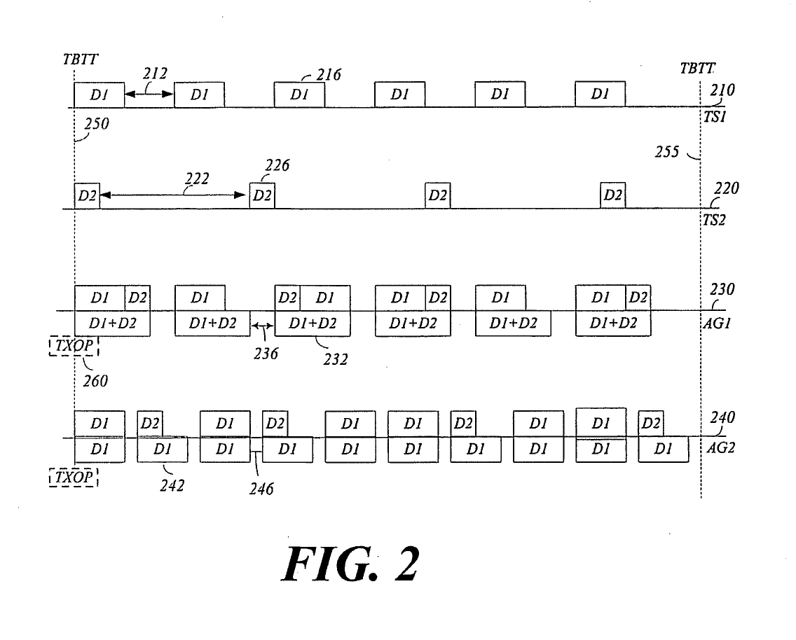

Turning to FIG. 2, an illustration of a timing diagram 200 of an aggregated service according to some exemplary embodiments of the present invention is shown. Although the scope of the present invention is not limited in this respect, scheduler 150 may schedule services to poll data of a first traffic stream (TS1) 210 and a second traffic stream (TS2) 220. According to some embodiment of the invention, TS1 210 and TS2 220 may be periodic traffic streams. In this exemplary embodiment of the invention, scheduler 150 may schedule services to station 180. For example, scheduler 150 may schedule service to poll data from TS1 210 with the following parameters: a polling interval 212 (I1) and a duration of service period 216 (D1). In addition, scheduler 150 may schedule a service to station 180 to poll data from TS2 220 with interval and duration parameters 222 (I2) and 226 (D2), respectively.

Although the scope of the present invention is not limited in this respect, in one embodiment of the present invention, station 180 may transmit a request for reservation of TXOP 260. Receiver 120 of AP 110 may receive TXOP 260 and aggregator 160 may aggregate parameters of TS1 210 and TS2 220 services into a single aggregated service using an aggregation scheme 230 (AG1) as shown, e.g., according to the following set of equations:
Iₐ=min(I₁, I₂) and Dₐ=D₁+D₂ (1)
wherein Iₐ may represent an aggregate polling interval 236 and Dₐ may represent an aggregate duration 232. According to Equations 1, aggregator 160 may select the aggregate polling interval Iₐ (236) to be the shorter of polling intervals I1 (212) and I2 (222), and may select the single aggregate duration Dₐ (232) as the sum of durations D1 (216) and D2 (226).

According to this exemplary embodiment of the invention, TS1 may include N1 polls per beacon period and TS2 may include N2 polls per beacon period. For example, as shown in FIG. 2, TS1 may include six polls per beacon period (e.g. N1=6) and TS2 220 may include four polls per beacon period (e.g. N2=4), wherein the beacon period is the time between a target beacon transmitted time (TBTT) 250 and a TBTT 255, if desired. Scheduler 150 may schedule an aggregated number of polls per beacon period Nₐ according to the equation: Nₐ=max (N1, N2), if desired. In the exemplary embodiment of aggregation scheme 230 (AG1), Nₐ=6.

Although the scope of the present invention is not limited in this respect, according to another exemplary embodiment of the invention, station 180 may transmit a request for reservation of TXOP 260. Receiver 120 of AP 110 may receive the request of reservation of TXOP 260 and aggregator 160 may aggregate parameters of TS1 210 and TS2 220 services into a single aggregated service according to the following set equations:
Iₐ=(I₁*I₂)/(I₁+I₂) and Dₐ=max(D₁, D₂) (2)

According to this exemplary embodiment of the invention, as in the previous embodiment, TS1 may have N1 polls per beacon period and TS2 may have N2 polls per beacon period. For example, as shown in FIG. 2, TS1 may have six polls per beacon period (e.g. N1=6) and TS2 220 may have four polls per beacon period (e.g. N2=4). However, in contrast to the previous embodiment, in this embodiment, scheduler 150 may schedule aggregated polls per beacon period Nₐ according to the alternate equation: Nₐ=(N1+N2), if desired, resulting in an aggregation scheme 240 (AG2) as shown.

Although the scope of the present invention is not limited in this respect, AP 110 may transmit data streams to station 180 over downstream 147 (FIG. 1). According to one embodiment of the invention, aggregator 160 may use aggregation scheme AG1 230 and scheduler 150 may allocate a channel time according to the equation: T1=max(N1, N2)*(D1+D2), if desired. According to other embodiments of the invention aggregator 160 may use aggregation scheme AG2 (240), and scheduler 150 may allocate a channel time according to the equation:

T2=(N1+N2)*max(D1, D2), if desired. With regard to embodiments of the present invention, the channel time (e.g. T1 and/or T2) may be the total time that may be used to transmit and/or to poll a data stream and/or an aggregated data stream within the beacon interval, although the scope of the present invention is in no way limited in this respect.

According to some embodiments of the invention, aggregator 160 may be able to select the aggregation sachem and/or algorithm and/or mechanism (e.g. aggregation schemes 230 and 240) according to a desired channel time. For example, if it is desired that the channel time be as short as possible, scheduler 150 may schedule aggregated services according to the aggregation algorithm and/or mechanism represented by aggregation scheme AG1 230, if desired.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed is:

1. A method comprising:
aggregating at least a first polling service of a first data traffic stream with a second polling service of a second data traffic stream into an aggregated service by aggregating a first service time period of the first polling service, a second service time period of the second polling service and polling intervals of at least the first and second polling services.

2. The method of claim 1, comprising:
periodically performing the aggregated service.

3. The method of claim 1, comprising:
selecting an aggregation scheme of the aggregated service according to a desired allocation of channel time.

4. The method of claim 1, wherein aggregating comprises:
adding the first service time period of the first polling service to the second service time period of the second service; and
selecting a shorter polling interval of the at least first and second services.

5. The method of claim 1, wherein aggregating comprises:
adding the first service time period of the first polling service to the a second service time period of the second service to provide an aggregated service time period of the aggregated service; and
setting a number of polls per beacon period of the aggregated service based on maximal number of polls per beacon period of the first and second polling services.

6. The method of claim 5, comprising:
allocating a channel time based on the aggregated service time period and the number of polls per beacon period of the aggregated service.

7. The method of claim 1, wherein aggregating comprises:
setting the aggregated service time period based on a longest of the service time periods of the first and second polling services; and
setting a number of polls per beacon period of the aggregated service based on a sum of a first number of polls per beacon period of the first polling service and a second number of polls per beacon period of the second polling service.

8. The method of claim 7, comprising:
allocating a channel time based on the aggregated service time period and the number of polls per beacon period of the aggregated service.

9. An apparatus comprising:
an aggregator to aggregate at least a first polling service of the first traffic stream with a second polling service of the second traffic stream into an aggregated service by aggregating a first service time period of the first polling service, a second service time period of the second polling service and polling intervals of the at least first and second polling services.

10. The apparatus of claim 9, comprising:
a scheduler capable of periodically scheduling the aggregated service.

11. The apparatus of claim 9, wherein the aggregator is able to select an aggregation scheme of the aggregated service according to a desired allocation of a channel time.

12. The apparatus of claim 9, wherein the aggregator is capable of:
adding the first service time period of the first polling service to the second service time period of the second service; and
selecting a shorter polling interval of the at least first and second services.

13. The apparatus of claim 9, wherein the aggregator is capable of:
adding the first service time period of the first polling service to the a second service time period of the second service to provide an aggregated service time period of the aggregated service; and
setting a number of polls per beacon period of the aggregated service based on maximal number of polls per beacon period of the first and second polling services.

14. The apparatus of claim 13, wherein the scheduler is capable of:
allocating a channel time based on the aggregated service time period and the number of polls per beacon period of the aggregated service.

15. The apparatus of claim 9, wherein the aggregator is capable of:
setting an aggregated service time period of the aggregated service by selecting a longest service time period of a first and second polling services; and
setting a number of polls per beacon period of the aggregated service by adding a first number of polls per beacon period of the first polling service to a second number of polls per beacon period of the second polling service.

16. The apparatus of claim 15, wherein the scheduler is capable of:
allocating a channel time based on the aggregated service time period and the number of polls per beacon period of the aggregated service.

17. A wireless communication system comprising:
an access point to provide two or more data stream polling services to a station comprises:
an aggregator to aggregate at least a first polling service of the first traffic stream with a second polling service of the second traffic stream into an aggregated service by aggregating a first service time period of the first polling service, a second service time period of the second polling service and polling intervals of the at least first and second polling services.

18. The wireless communication system of claim 17, comprising:
a scheduler capable of periodically scheduling the aggregated service.

19. The wireless communication system of claim 17, wherein the aggregator is able to select an aggregation scheme of the aggregated service according to a desired allocation of a channel time.

20. The wireless communication system of claim 17, wherein the aggregator is capable of:
adding the first service time period of the first polling service to the second service time period of the second service; and
selecting a shorter polling interval of the at least first and second services.

21. The wireless communication system of claim 17, wherein the aggregator is capable of:
adding the first service time period of the first polling service to the a second service time period of the second service to provide an aggregated service time period of the aggregated service; and
setting a number of polls per beacon period of the aggregated service based on maximal number of polls per beacon period of the first and second polling services.

22. The wireless communication system of claim 21, wherein the scheduler is capable of:
allocating a channel time based on the aggregated service time period and the number of polls per beacon period of the aggregated service.

23. The wireless communication system of claim 17, wherein the aggregator is capable of:
setting an aggregated service time period of the aggregated service by selecting a longest service time period of a first and second polling services; and
setting a number of polls per beacon period of the aggregated service by adding a first number of polls per beacon period of the first polling service to a second number of polls per beacon period of the second polling service.

24. The wireless communication system of claim 23, wherein the scheduler is capable of:
allocating a channel time based on the aggregated service time period and the number of polls per beacon period of the aggregated service.

25. A communication device comprising:
a dipole antenna to poll data from at least first and second traffic streams;
an aggregator to aggregate at least a first polling service of the first traffic stream with a second polling service of the second traffic stream into an aggregated service by aggregating a first service time period of the first polling service, a second service time period of the second polling service and polling intervals of the at least first and second polling services.

26. The communication device of claim 25, comprising:
a scheduler capable of periodically scheduling the aggregated service.

27. The communication device of claim 25, wherein the aggregator is able to select an aggregation scheme of the aggregated service according to a desired allocation of a channel time.

28. The communication device of claim 25, wherein the aggregator is capable of:
adding the first service time period of the first polling service to the second service time period of the second service; and
selecting a shorter polling interval of the at least first and second services.

29. The communication device of claim 25, wherein the aggregator is capable of:
adding the first service time period of the first polling service to the a second service time period of the second service to provide an aggregated service time period of the aggregated service; and
setting a number of polls per beacon period of the aggregated service based on maximal number of polls per beacon period of the first and second polling services.

30. The communication device of claim 29, wherein the scheduler is capable of:
allocating a channel time based on the aggregated service time period and the number of polls per beacon period of the aggregated service.

31. The communication device of claim 25, wherein the aggregator is capable of:
setting an aggregated service time period of the aggregated service by selecting a longest service time period of a first and second polling services; and
setting a number of polls per beacon period of the aggregated service by adding a first number of polls per beacon period of the first polling service to a second number of polls per beacon period of the second polling service.

32. The communication device of claim 31, wherein the scheduler is capable of:
allocating a channel time based on the aggregated service time period and the number of polls per beacon period of the aggregated service.

33. An article comprising: a storage medium, having stored thereon instructions, that when executed, result in:
aggregating at least a first polling service of a first data traffic stream with a second polling service of a second data traffic stream into an aggregated service by aggregating a first service time period of the first polling service, a second service time period of the second polling service and polling intervals of at least the first and second polling services.

34. The article of claim 33, wherein the instructions when executed result in:
periodically performing the aggregated service.

35. The article of claim 33, wherein the instructions when executed result in:
selecting an aggregation scheme of the aggregated service according to a desired allocation of channel time.

36. The article of claim 33, wherein the instruction of aggregating when executed results in:
adding the first service time period of the first polling service to the second service time period of the second service; and
selecting a shorter polling interval of the at least first and second services.

37. The article of claim 33, wherein the instruction of aggregating when executed results in:
adding the first service time period of the first polling service to the a second service time period of the second service to provide an aggregated service time period of the aggregated service; and
setting a number of polls per beacon period of the aggregated service based on maximal number of polls per beacon period of the first and second polling services.

38. The article of claim 37, wherein the instructions when executed result in:
allocating a channel time based on the aggregated service time period and the number of polls per beacon period of the aggregated service.

39. The article of claim 33, wherein the instruction of aggregating when executed results in:
setting the aggregated service time period based on a longest of the service time periods of the first and second polling services; and
setting a number of polls per beacon period of the aggregated service based on a sum of a first number of polls per beacon period of the first polling service and a second number of polls per beacon period of the second polling service.

40. The article of claim 39, wherein the instructions when executed result in:
allocating a channel time based on the aggregated service time period and the number of polls per beacon period of the aggregated service.
